(19) United States
(12) Patent Application Publication
(10) Pub. No.: US 2025/0116388 A1
(43) Pub. Date: Apr. 10, 2025

(54) LIGHTING ARRANGEMENT COMPRISING A LENS BODY

(71) Applicant: SIGNIFY HOLDING B.V., EINDHOVEN (NL)

(72) Inventors: ANNA WILHELMINA MARIA DE BEST, VELDHOVEN (NL); MICHEL CORNELIS JOSEPHUS MARIE VISSENBERG, ROERMOND (NL); MARCELLINUS PETRUS CAROLUS MICHAEL KRIJN, EINDHOVEN (NL); BARTEL MARINUS VAN DE SLUIS, EINDHOVEN (NL); LEENDERT TEUNIS ROZENDAAL, VALKENSWAARD (NL)

(21) Appl. No.: 18/729,754

(22) PCT Filed: Jan. 25, 2023
(86) PCT No.: PCT/EP2023/051802

§ 371 Date: Jul. 17, 2024

(30) Foreign Application Priority Data
Jan. 31, 2022 (EP) 22154319.2

(51) Int. Cl. F21V 5/04; F21S 4/20; F21Y 113/00; F21Y 115/10

(52) U.S. Cl. CPC F21V 5/04; F21S 4/20; F21Y 2113/00; F21Y 2115/10

(57) ABSTRACT

A lighting arrangement 100, comprising an elongated lens body 110, extending in a length direction, L, and being defined by a transversely extending and mutually opposing first end surface, E1, and second end surface, E2, and a first side surface, S1, a second side surface, S2, and a third side surface, S3. Each side surface connects the first end surface with the second end surface. The lens body comprises at least one recess 120 arranged along the length direction and only at at least one of the first side surface and second side surface, wherein the first side surface is oriented at an angle α with the second side surface, wherein 60°<=α<=120°. The lighting arrangement further comprises at least one array 130 of a plurality of light emitting diodes 140, LEDs, arranged in at least one of the at least one recess.

### FIELD OF THE INVENTION

The present invention generally relates to a lighting arrangement. More specifically, the present invention is related to a lighting arrangement comprising a lens body.

### BACKGROUND OF THE INVENTION

The market for light emitting diodes (LEDs) continues to expand. LEDs have numerous advantages over conventional light sources such as incandescent lamps, fluorescent lamps and sodium lamps. Being more energy-efficient, having a longer lifespan and a higher efficiency, as well as providing design flexibility, are to name some.

One trend is to combine the advantageous properties of LEDs according to the above with the use of flexible strips to be able to provide light to secluded or confined areas such as shelves and kitchen cabinets. Flexible LED-strips can be cut or extended to a desired length and can therefore fulfill several lighting needs. As they are flexible, they can be bent and shaped to different formations. Furthermore, they are compact, providing easy installation and use.

The intensity profile of standard flexible LED-strips is often Lambertian, or close to Lambertian. This property may be unwanted when used with e.g. linear shelves or counters, as these areas of use often require a linear spotlight where most of the light is collimated and directed towards a surface, instead of a Lambertian intensity distribution. In addition to this, the use of standard flexible LED-strips can also result in glare from the light source, and the possibility of noticing individual light sources. These consequences can be perceived as unpleasant to persons nearby the light source.

Hence, it is of interest to provide a continuous and compact linear light source, preferably with LEDs, to illuminate a surface with a targeted light output, while preventing glare.

It is an object of the present invention to provide a lighting arrangement which can provide a targeted light output, whilst at the same time preventing glare from the arrangement.

This and other objects are achieved by a lighting arrangement having the features in the independent claim. Preferred embodiments are defined in the dependent claims.

Hence, according to the present invention, there is provided a lighting arrangement, comprising an elongated lens body, extending in a length direction, L, and being defined by a transversely extending and mutually opposing first end surface, E₁, and second end surface, E₂, and a first side surface, S₁, a second side surface, S₂, and a third side surface, S₃. Each side surface connects the first end surface with the second end surface. The lens body comprises at least one recess extending along the length direction and only at at least one of the first side surface and second side surface, wherein the first side surface is oriented at an angle, α, with the second side surface, wherein 60°<=α<=120°. The lighting arrangement further comprises at least one array of a plurality of light emitting diodes, LEDs, arranged in at least one of the at least one recess. According to the present invention there is provided an extension of the first side surface extending beyond an edge, C, between the first side surface and the second side surface, wherein the extension may be configured to be bent towards, and attached to, at least one of the lens body and the second side surface. Hence, an extension of the first side surface may be bent towards, and attached to, the lens body and/or the second side surface. The present embodiment is particularly advantageous in that it adds stiffness to the lighting arrangement, making it more robust, when said extension is bent (and optionally attached) towards said second side surface. Furthermore, the extension of the first side surface may hide e.g. any incisions being made in the lens body and/or the second side surface, making it more aesthetically attractive. The extension may partially or fully cover the second side surface, for example may be reflective and in this way determine the (partial) reflectivity of the second side surface.

Thus, the present invention is based on the idea of a compact linear lighting arrangement or system which is able to provide a targeted light output, predominantly suitable for illuminating elongated surfaces, by emission of an asymmetrical beam in a direction transverse to the length direction L whilst preventing glare.

It will be appreciated that the beam of the light emitted from the array(s) of the plurality of LEDs may be asymmetrical. This result in a minimization of glare as the beam does not irradiate unidirectionally, thus providing a more consistent illumination of a space or area, such as the space wherein the lighting arrangement resides.

The present invention is further advantageous in that it enables providing a targeted light output as a result of the lens body in combination of the placement of the array(s) of the plurality of LEDs within the at least one recess. This facilitates providing an illumination of a more distinct part of a space or area.

According to the lighting arrangement of the present invention, there is provided at least one array of a plurality of light emitting diodes, LEDs. By the term “array”, it is here meant a (linear) arrangement, or the like. Hence, by the term “at least one array of a plurality of LEDs”, it is here meant that the array(s) of LEDs constitute a linear arrangement or chain of LEDs, or the like.

By “lens body”, it is here meant an (elongated) element, structure or the like of a translucent material, which is configured to affect light in such a manner that at least some light can pass through the lens body. By the term “recess”, it is here meant a hollow enclosure that is set back or indented in a surface of an object. Hence, by “the lens body comprises at least one recess”, it is here meant that the lens body comprises one or more hollow enclosures. Such an elongated lens body can typically be manufactured via extrusion.

According to an embodiment of the present invention there is provided a lighting arrangement wherein the at least array of a plurality of LEDs constitutes a continuous linear light source. Hence, the light emitted from the array(s) of a plurality of LEDs may constitute a continuous light source. The present embodiment is advantageous in that the array(s) of a plurality of LEDs may constitute a continuous linear light source, thereby even further reducing the risk of glare. The risk of individual “light pixels” being noticeable is also further reduced, therefore resulting in an even more pleasant light experience for persons in a space wherein the lighting arrangement resides.

According to an embodiment of the present invention there is provided a lighting arrangement wherein at least one of the first side surface S₁ and the second side surface S₂ may be at least partially reflective. Hence, the first side of the first side surface and/or the first side of the second side surface may be partially or fully reflective, where both these sides face the lens body. The present embodiment is advantageous in that the beam of the array(s) of the plurality of LEDs may be reflected to some extent, thus improving the intensity distribution of the light of the array(s) of the plurality of LEDs. This enables a smaller space to be illuminated, with a smaller spread of the light of the array(s) of the plurality of LEDs, and thus resulting in higher illuminance. Furthermore, the potential glare of the light of the array(s) of the plurality of LEDs is further reduced, presenting a more pleasant light for users. It will be appreciated that the beam of the light of the array(s) of the plurality of LEDs can be shaped as a result of the first side of the first side surface and/or the first side of the second side surface being at least partially reflective. This is advantageous in that the present embodiment may facilitate different lighting needs, e.g. a provision of light to a specific area in a space where the lighting arrangement resides.

According to an embodiment of the present invention, the lighting arrangement may comprise at least one fastening element arranged on (an outer side of) at least one of the second side of the first side surface and the second side of the second side surface. In other words, the lighting arrangement may comprise a fastening element arranged on the second side of the first side surface, and/or on the second side of the second side surface, where both (outer sides of) these sides face away from the lens body. The present embodiment is particularly advantageous in that the installation of the lighting arrangement is done more easily. Additionally, the arrangement of the fastening element(s) of the present embodiment provides a more versatile approach in mounting the lighting arrangement. According to an embodiment of the present invention, the lighting arrangement may comprise at least one element constituting a linear structure which may extend in the length direction, L. The at least one element may be arranged in at least one of the at least one recess, wherein the at least one element may partially enclose the at least one array of a plurality of LEDs. In a cross section, P, of the lighting arrangement along the length direction, L, the at least one element may extend in the cross section, P, to the lens body, whereby the at least one element may provide a spacing, A, in the cross section, P, between the lens body and the at least one array of a plurality of LEDs. In other words, the element(s), constituting a linear structure extending in the length direction, L, may be arranged in the recess and providing a spacing, A, between the lens body and the array(s) of a plurality of LEDs. The element(s) may partially enclose the array(s) of a plurality of LEDs and extend in the cross section, P, towards the lens body. The present embodiment is advantageous in that the linear structure of element(s) ensure(s) a spacing, A, between the lens body and the array(s) of the plurality of LEDs, thus avoiding physical contact between them in the recess. As optical contact between lens and array(s) could have an adverse effect on the shape of the beam and could also affect the spectrum in an undesired manner, the present embodiment is advantageous in that one or more of these negative influences could be mitigated or avoided, resulting in an even more improved light output.

According to an embodiment of the present invention, at least one of the at least one element may be at least partially reflective. Hence, one or more of the elements may be partially or fully reflective. The present embodiment is advantageous in that the element(s) can reflect the beam of the light of the array(s) of the plurality of LEDs, thus improving the intensity distribution of the light even further. Consequentially, this could result in a larger space being illuminated, with an even wider spread of the light. Furthermore, the potential glare of the light of the array(s) of the plurality of LEDs is again reduced, presenting a more pleasant light for users. Is should be noted that the beam of the light of the array(s) of the plurality of LEDs can be adjusted as a result of the element being at least partially reflective. This is favorable as the present embodiment may serve different lighting needs, e.g. delivering light to a specific area in a larger space where the lighting arrangement resides.

According to an embodiment of the present invention, the lighting arrangement may comprise at least one of a first set of at least two adjacent arrays of a plurality of LEDs and a second set of at least two adjacent arrays of a plurality of LEDs, wherein at least one of the first set of at least two adjacent arrays of a plurality of LEDs may be arranged (within the lens body) in the at least one recess arranged along the first side surface, and the second set of at least two adjacent arrays of a plurality of LEDs may be arranged (within the lens body) in the at least one recess arranged along the second side surface, is fulfilled. Hence, a first set of two or more adjacent arrays of a plurality of LEDs may be arranged in a recess along the first side surface, and a second set of two or more adjacent arrays of a plurality of LEDs may be arranged in a recess along the second side surface. The present embodiment is particularly advantageous in that the lighting arrangement may illuminate a greater space or highlight different sections within the illuminated space in which the lighting arrangement is mounted, improving the overall intensity distribution. Following this, the risk of glare may decrease even further. In addition, it entails the lighting arrangement to be versatile regarding different lighting needs and/or desires regarding e.g. providing light to a specific area.

According to an embodiment of the present invention the lighting arrangement may comprise a control unit configured to control at least one of the at least one array of a plurality of LEDs independently. Hence, the control unit may control multiple arrays of a plurality of LEDs independently of each other. The present embodiment is advantageous in that the light of the array(s) of the plurality of LEDs can be controlled via the control unit according to different lighting needs and/or desires regarding e.g. providing light to a specific area.

According to an embodiment of the present invention the lighting arrangement may comprise a single recess arranged along the first side surface, and a single array of a plurality of LEDs, wherein the single array of a plurality of LEDs may be (within the lens body) arranged in the single recess, and the second side surface may be at least partially reflective.

According to an embodiment of the present invention there are provided at least two arrays of a plurality of LEDs, wherein at least one first array of a plurality of LEDs may be arranged to emit first light, and at least one second array of a plurality of LEDs may be arranged to emit second light, wherein the first light and the second light may be different. In other words, two arrays of a plurality of LEDs may emit different light. By the wording “the first light and the second light may be different” it is here meant that at least one property of the first light is different (i.e. not the same) to that (those) of the second light, such as different wavelengths, colors, intensities, etc. The present embodiment is advantageous in that it is further adaptable regarding different lighting needs, requirements and/or desired settings as well as being aesthetically attractive. Additionally, the present embodiment is further advantageous in that multiple arrays may be located such that the respective lights of the plurality of LEDs may interfere with each another. The embodiment entails the lighting arrangement to be versatile regarding different lighting needs and/or desires regarding e.g. providing light to a specific area.

According to an embodiment of the present invention, the lighting arrangement may be flexible. The present embodiment is particularly advantageous in that the lighting arrangement may be wound up on e.g. a roll, making it easier to transport and handle. In addition to this, the present embodiment facilitates mounting of the lighting arrangement. Furthermore, the flexibility broadens the possible spaces wherein the lighting arrangement may be mounted, making the present invention more adaptable to different lighting needs and/or desired settings.

According to an embodiment of the present invention there is provided that, in a cross section, P, of the lighting arrangement along the length direction, L, the lens body may further be defined by the side surface S₃ being curved around the length direction L according to an arc, D. Said arc D having a first end point, Z₁, of/at the first side surface and a second end point, Z₂, of/at the second side surface. Hence, the arc, D, defines a shape of the lens body between the first and second end points, Z₁, Z₂, wherein the shape may be convex. The present embodiment is advantageous in that it generates an asymmetrical beam of the light of the array(s) of the plurality of LEDs, thereby illuminating a desired space while minimizing unwanted glare to people occupying a space where the lighting arrangement resides.

According to an embodiment of the present invention the second side surface may be perpendicular to the first side surface, whereby the first side surface and the second side surface may define and span the lens body to have the shape of a quarter-circular cylinder. The present embodiment is particularly advantageous in that it optimizes the light distribution. Therefore, the present embodiment may further minimize glare from the light of the array(s) of the plurality of LEDs.

According to an embodiment of the present invention, the lighting arrangement may comprise at least one incision provided perpendicular to the length direction, L. The at least one incision, i.e. a plurality of incisions, are arranged essentially parallel next to each other along the length direction, L, in at least one of the lens body and the second side surface. Optionally, also the extension may comprise (partial) incisions running parallel to and being located at the incisions in the lens body. By “incision”, it is here meant a cutting, a groove, or the like. The present embodiment is advantageous in that the incisions(s) may increase the flexibility of the lighting arrangement. This facilitates the transport and handling of the lighting arrangement, as it may be wound up, e.g. on a roll. In addition to this, the present embodiment may facilitate a mounting of the lighting arrangement, for example on relatively sharped curved substrates. Moreover, the present embodiment provides the lighting arrangement to be further adaptable to different lighting needs and/or desired settings.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIGS. 1a and 1b schematically show a lighting arrangement according to exemplifying embodiments of the present invention in exemplifying installments of the present invention,

FIG. 2 schematically shows a lighting arrangement according to an exemplifying embodiment of the present invention, comprising an array of a plurality of LEDs,

FIG. 3 schematically shows a lighting arrangement according to an exemplifying embodiment of the present invention,

FIG. 4 schematically shows a lighting arrangement with a control unit according to an exemplifying embodiment of the present invention, and

FIG. 5 schematically shows a lighting arrangement according to an exemplifying embodiment of the present invention.

### DETAILED DESCRIPTION

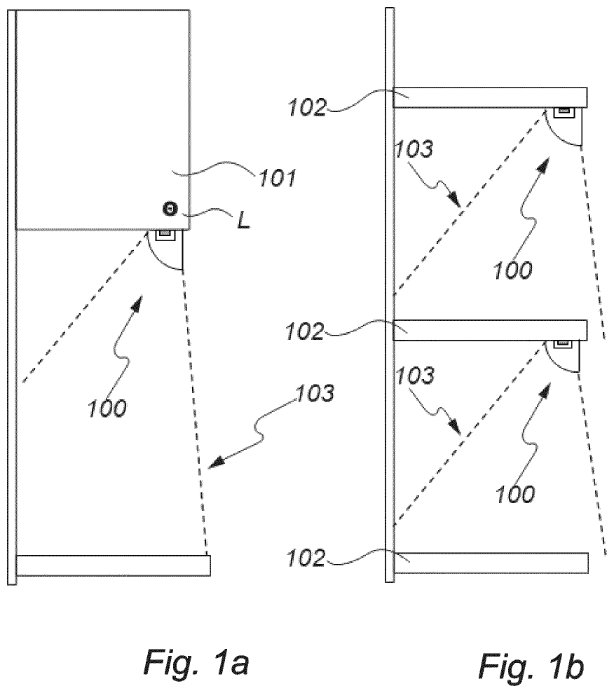

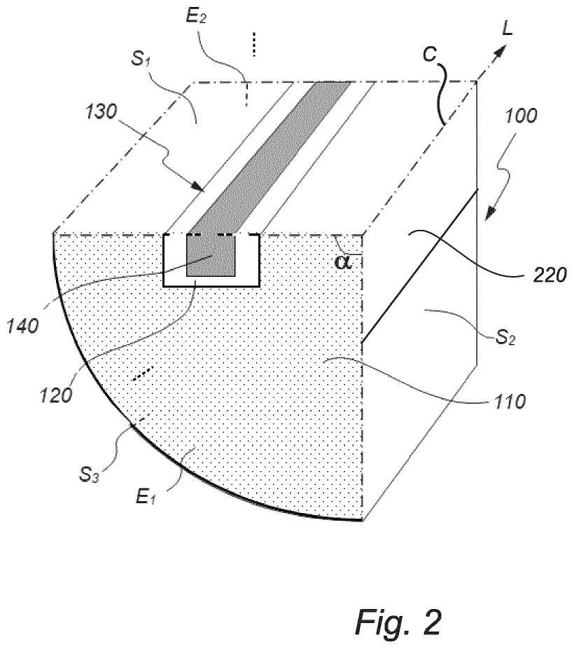

FIGS. 1a and 1b are schematic views of a lighting arrangement 100 according to exemplifying embodiments of the present invention in exemplifying installments. It should be noted that the purpose of FIGS. 1a and 1b is to provide an increased understanding of the concept of the lighting arrangement 100, and that a more detailed description of the features of the lighting arrangement 100 is provided in FIGS. 2-5 and the associated text.

In FIG. 1a, the lighting arrangement 100 is installed underneath a (kitchen) cupboard 101, whereas in FIG. 1b, (two) lighting arrangements 100 are installed underneath respective shelves 102. It should be noted that other arrangements and/or installments of the lighting arrangement 100 than those illustrated are feasible. By the lighting arrangement 100, the features of which are presented in more detail in the following, a (targeted) light output 103 may be provided. The light output 103 is asymmetrical in a direction transverse to a length direction L of the elongated lighting arrangement 100.

FIG. 2 is a schematic view of a lighting arrangement 100, comprising at least one array 130 of a plurality of LEDs 140. LED lamps of this type are very beneficial due to being aesthetically attractive as well as having a reduced power consumption, having a longer operational lifespan and a higher efficiency in regard to converting electrical energy into light energy in addition to providing design flexibility.

The lighting arrangement 100 comprises a first side surface, S₁, and a second side surface, S₂, wherein the second side surface, S₂, forms an angle, α, wherein 60°<=α<=120°, with respect to the first side surface, S₁. The angle, α, is preferably 70°<α<110°, more preferably 80°<α<100°, and most preferably 88°<α<92°. According to the embodiment shown in FIG. 2, α=90°.

The lighting arrangement 100 further comprises at least one array 130 of a plurality of LEDs 140, and a single array 130 of LEDs 140 is shown in FIG. 2. The LEDs 140 are arranged in an array, i.e. a linear configuration or arrangement, along a length direction, L. Thus, the lighting arrangement 100 provides an aligned light source. The plurality of LEDs 140 of an array 130 may be placed adjacent to each other with a distance of preferably <=8 mm, more preferably <=4 mm, and most preferably <=2 mm.

The lighting arrangement 100 further comprises a lens body 110 arranged between the first side surface, S₁ and the second side surface, S₂, whereby the first side surface, S₁, and the second side surface, S₂, define and span the lens body 110. The lens body 110 may comprise an encapsulant (not shown), which in turn may comprise a translucent material. In addition to this, the encapsulant may further comprise a light-scattering material configured to scatter light emitted from the plurality of LEDs 140. Furthermore, the encapsulant may further comprise a color-converting material, such as phosphor, configured to convert light emitted from the plurality of LEDs 140 to light of a desired color temperature. For example, the color-converting material may convert blue light emitted from the plurality of LEDs 140 to white light. By the term “encapsulant”, it is here meant a material, element, arrangement, or the like, which is configured or arranged to at least partially surround, encapsulate and/or enclose the array(s) 130 of plurality of LEDs 140. By the term “translucent material”, it is here meant a material, composition and/or substance which is translucent and/or transparent for visible light.

The lens body 110 comprises at least one recess 120, arranged along at least one of the first side surface, S₁, and the second side surface, S₂. The at least one recess 120 constitutes a hollow which is large enough to at least partially surround and/or enclose at least one array 130 of a plurality of LEDs 140. The recess(es) 120 is (are) preferably large enough to maintain a spacing between the lens body 110 and the at least one array 130 of a plurality of LEDs 140, thus avoiding physical contact between them. To obtain an acceptable light distribution, the at least one array 130 of a plurality of LEDs 140 should preferably not reach past at least one, more preferably neither, of the first side surface, S₁ and the second side surface, S₂. The lighting arrangement 100 further comprises an extension 220 of the first side surface, S1, extending beyond an edge, C, between the first side surface, S1, and the second side surface, S2. The extension 220 of the first side surface, S1, is bent towards and attached to the second side surface, S2 to partially cover the second side surface S2. The extension 220 of the first side surface, S1, may be reflective to hide the incision(s) 210 in at least one of the lens body 110 and the second side surface, S2 and/or to further tune the beam properties of the lighting arrangement.

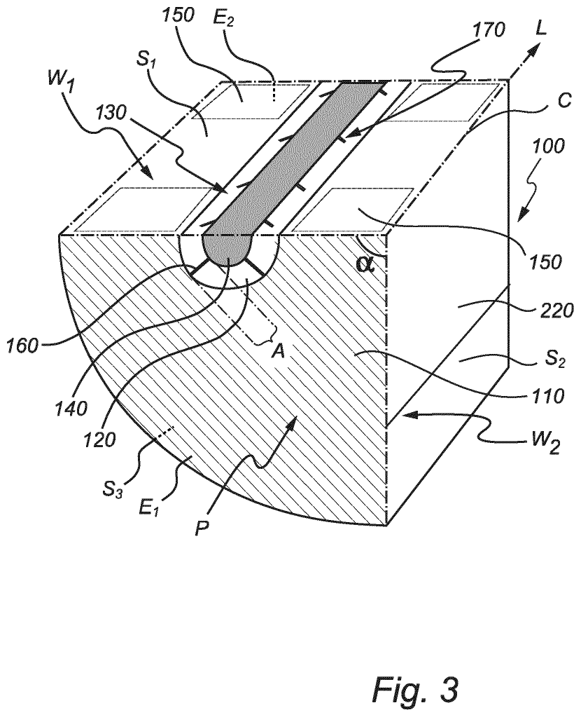

FIG. 3 schematically shows a lighting arrangement 100 according to an exemplifying embodiment of the present invention. It should be noted that the lighting arrangement 100 shown in FIG. 3 has many features in common with the lighting arrangement 100 shown in FIG. 2, and it is hereby referred to FIG. 2 and the associated text for an increased understanding of the features and/or functions of the lighting arrangement 100. In FIG. 3, the lighting arrangement 100 comprises a first side surface, S₁, and a second side surface S₂. The first side surface, S₁, and/or the second side surface, S₂, may be at least partially reflective for light. Thus, the first and/or the second side surface(s), S₁, S₂, can be partially or fully reflective for light. The first and/or the second side surface(s), S₁, S₂, may comprise e.g. a reflective coating or a sheet material to obtain the reflection property.

The lighting arrangement 100 further comprises at least one fastening element 150 arranged on a first outer side W₁ of the first side surface, S₁, i.e. outside the lens body, and/or on a second outer side W₂ of the second side surface, S₂, i.e. outside the lens body. The fastening element 150 enables mounting the lighting arrangement 100 to e.g. a shelf or cupboard. For example, the fastening element 150 may comprise an adhesive layer to facilitate installation of the lighting arrangement 100.

The lighting arrangement 100 further comprises at least one element 160 constituting a linear structure 170 arranged in at least one of the at least one recess 120, ensuring a spacing, A, between the lens body 110 and the at least one array 130 of a plurality of LEDs 140. The element(s) 160 extend(s) in a cross section, P, of the lighting arrangement 100 along the length direction, L. The spacing, A, enables avoiding physical contact between the lens body 110 and the at least one array 130 of a plurality of LEDs 140 when the lighting arrangement 100 is e.g. being transported in a rolled up mode or during installation. In addition, the spacing, A, further enables avoiding optical contact between the lens body 110 and the at least one array 130 of a plurality of LEDs 140 when the lighting arrangement 100 is installed in e.g. a bended mode. The linear structure 170, which may comprise at least one element 160 and extending in the length direction, L, may extend throughout the at least one recess 120 it is arranged in, or only part of the at least one recess 120. Furthermore, said at least one element 160 may be at least partially reflective. Thus, the at least one element 160 may be partially or fully reflective. The at least one element 160 may comprise e.g. a reflective coating or a sheet material to obtain the reflective property. The shape of the at least one element 160 may be designed to optimize the light distribution from the at least one array 130 of a plurality of LEDs 140. The lighting arrangement 100 further comprises an extension 220 of the first side surface, S1, extending beyond an edge, C, between the first side surface, S1, and the second side surface, S. The extension 220 of the first side surface, S1, is bent towards and attached to the second side surface, S2 to partially cover the second side surface S2. The extension 220 of the first side surface, S1, may be opal to hide the incision(s) 210 in at least one of the lens body 110 and the second side surface, S2 and/or to further tune the beam properties of the lighting arrangement.

The lighting arrangement 100 comprises the first side surface, S₁, and the second side surface, S₂. It should be noted that it is possible to attach additional components to the first outer side W₁ of the first side surface, S₁, and/or to the second outer side W₂ of the second side surface S₂, e.g. a display, a digital screen or decorative patterns.

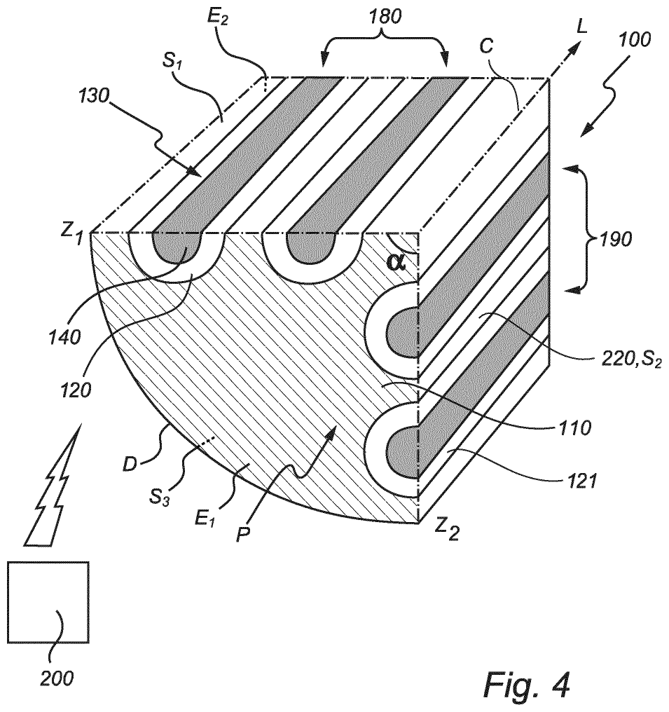

FIG. 4 schematically shows a lighting arrangement 100 according to an exemplifying embodiment of the present invention. It should be noted that the lighting arrangement 100 shown in FIG. 4 has many features in common with the lighting arrangement 100 shown in FIG. 2 and/or FIG. 3, and it is hereby referred to FIG. 2 and/or FIG. 3, and the respective associated text for an increased understanding of the features and/or functions of the lighting arrangement 100. The lighting arrangement 100 comprises a first set 180 of two or more adjacent arrays 130 of a plurality of LEDs 140 and/or a second set 190 of two or more adjacent arrays 130 of a plurality of LEDs 140, wherein the first set 180 of two or more adjacent arrays 130 of a plurality of LEDs 140 may be arranged in a recess 120 arranged along the first side surface, S₁, and the second set 190 of two or more adjacent arrays 130 of a plurality of LEDs 140 may be arranged in a further recess 121 arranged along the second side surface, S₂. The first set 180 may be arranged to emit first light, and the second set 190 may be arranged to emit second light, wherein the first light and the second light are different. By “different” it is here meant that at least one property of the first set 180 of at least two adjacent arrays 130 of a plurality of LEDs 140 is not shared with the second set 190 of at least two adjacent arrays 130 of a plurality of LEDs 140 such as luminous flux, color temperature and/or color rendering. These different properties may allow the lighting arrangement 100 to display e.g. different color effects in a space or area wherein the lighting arrangement 100 resides.

The lighting arrangement 100 further comprises a control unit 200 configured to control at least one of the at least one array 130 of a plurality of LEDs 140 independently. The control unit 200 may be connected to the light arrangement 100 by wire or wirelessly. As the control unit may control the array(s) 130 independently, different arrays 130 may have different settings in regard to e.g. luminosity. Furthermore, the control unit 200 may control the beam width and/or the beam angle of the system by controlling the light output of the various array(s) 130 of the plurality of LEDs 140.

The lighting arrangement 100 further comprises a lens body 110, which, in a cross section, P, of the lighting arrangement 100 along the length direction, L, is further defined by an arc, D, between a first end point, Z₁, of the first side surface S₁ and a second end point, Z₂, of the second side surface S₂.

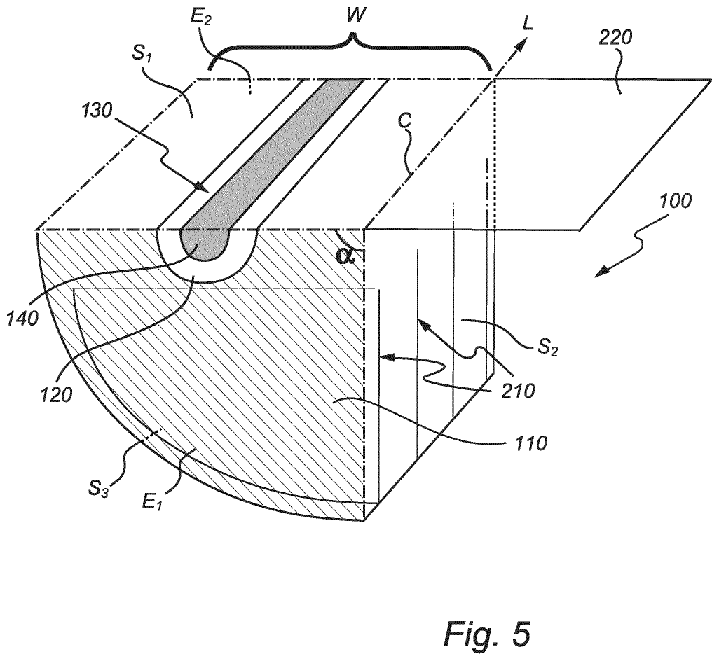

FIG. 5 schematically shows a lighting arrangement 100 according to an exemplifying embodiment of the present invention. It should be noted that the lighting arrangement 100 shown in FIG. 5 has many features in common with the lighting arrangement 100 shown in FIGS. 2-4, and it is hereby referred to this (these) figure(s), and the respective associated text, for an increased understanding of the features and/or functions of the lighting arrangement 100. The lighting arrangement 100 comprises a first side surface, S₁ and a second side surface, S₂, wherein the second side surface, S₂, is perpendicular to the first side surface, S₁, whereby the first side surface, S₁, and the second side surface, S₂, define and span a lens body 110 to have the shape of a quarter-circular cylinder. Consequentially, the angle, α, may be 90°. The shape of the lens body 110 may have a different shape, dimensions and/or size than depicted, such as a quarter of an elliptical cylinder, or slightly smaller/larger than a circular or elliptical cylinder lens.

The array 130 of plurality of LEDs is embodied as a flexible LED strip and the lens body 110 is made of a light transmissive, flexible material. The lighting arrangement 100 further comprises a plurality of incisions 210 (partially indicated in ghost) provided with a plurality of incisions 210 arranged along the length direction, L, in at least one of the lens body 110 and the second side surface S₂. Each incision 210 extends perpendicular to the length direction, L, and from the second side surface S₂ to the third side surface S₃. The incision(s) 210 may enable linear bending and therefore improving the flexibility of the lighting arrangement 100, thus enabling it to e.g. be wound up on a roll. Even though the lighting arrangement 100 may be flexible to some extent without at least one incision 210, the at least one incision 210 may improve the flexibility.

The lighting arrangement 100 further comprises an extension 220 of the first side surface, S₁, extending beyond an edge, C, between the first side surface, S₁, and the second side surface, S₂, wherein the extension 220 of the first side surface, S₁, is configured to be bent towards, and attached to, at least one of the lens body 110 and the second side surface, S₂. The extension 220 of the first side surface, S₁, may be bent to hide the incision(s) 210 in at least one of the lens body 110 and the second side surface, S₂. Furthermore, the extension 220 may add stiffness and robustness to the lighting arrangement 100.

The at least one array 130 of a plurality of LEDs 140 may be arranged within the at least one recess 120 arranged along the first side surface, S₁, and/or the second side 5 surface, S₂, wherein the first side surface, S₁, and/or the second side surface, S₂, has a width, W. The array(s) 130 of a plurality of LEDs 140 may be placed within the at least one recess 120 so that the distance between the array(s) 130 of a plurality of LEDs 140 and the edge, C, is <=W/2.

The person skilled in the art realizes that the present invention by no means is 10 limited to the preferred embodiments described above. On the contrary, many modifications and variations are possible within the scope of the appended claims. For example, one or more of the at least one recess 120, the at least one element 160, the arc, D, of the lens body 110 etc., may have different shapes, dimensions and/or sizes than those depicted/described.

1. A lighting arrangement, comprising
an elongated lens body, extending in a length direction, L, and being defined by a transversely extending and mutually opposing first end surface, E₁, and second end surface, E₂, and a first side surface, S₁, a second side surface, S₂, and a third side surface, S₃, each side surface connecting the first end surface with the second end surface,
wherein the lens body comprises at least one recess arranged along the length direction and only at least one of the first side surface and second side surface, and
wherein the first side surface is oriented at an angle, α, with the second side surface, wherein 60°<=α<=120°, and
at least one array of a plurality of light emitting diodes, LEDs, arranged in at least one of the at least one recess,
wherein an extension of the first side surface extends beyond an edge, C, between the first side surface, S1, and the second side surface, S2, and is configured to be bent towards, and attached to, at least one of the lens body and the second side surface, S2.

2. The lighting arrangement according to claim 1, wherein the at least one array of a plurality of LEDs constitutes a continuous linear light source.

3. The lighting arrangement according to claim 1, wherein at least one of
the first side surface, S₁, and the second side surface, S₂, is at least partially reflective.

4. The lighting arrangement according to claim 1, further comprising at least one fastening element arranged on at least one of a first (W₁) and second outer side (W₂) of the lens body of at least one of the first side surface, S₁, and the second side surface, S₂.

5. The lighting arrangement according to claim 1, comprising
at least one element constituting a linear structure and arranged in at least one of the at least one recess,
wherein the at least one element partially encloses the at least one array of a plurality of LEDs and, in a cross section, P, of the lighting arrangement along the length direction, L, extends in the cross section, P, to the lens body, whereby the at least one element provides a spacing, A, in the cross section, P, between the lens body and the at least one array of a plurality of LEDs, and
wherein the linear structure extends in the length direction, L.

6. The lighting arrangement according to claim 5, wherein at least one of the at least one element is at least partially reflective.

7. The lighting arrangement according to claim 1, further comprising at least one of
(i) a first set of at least two adjacent arrays of a plurality of LEDs and
(ii) a second set of at least two adjacent arrays of a plurality of LEDs, wherein at least one of
the first set of at least two adjacent arrays of a plurality of LEDs is arranged within the lens body in the at least one recess arranged along the first side surface, S₁, and
the second set of at least two adjacent arrays of a plurality of LEDs is arranged within the lens body in the at least one further recess arranged along the second side surface, S₂,
is fulfilled.

8. The lighting arrangement according to claim 1, comprising a control unit configured to control at least one of the at least one array of a plurality of LEDs independently.

9. The lighting arrangement according to claim 1, further comprising
a single recess arranged along the first side surface, S₁, and
a single array of a plurality of LEDs,
wherein the single array of a plurality of LEDs is arranged within the lens body in the single recess, and the second side surface, S₂, is at least partially reflective.

10. The lighting arrangement according to claim 1, comprising at least two arrays of a plurality of LEDs,
wherein at least one first array of a plurality of LEDs is arranged to emit first light, and at least one second array of a plurality of LEDs is arranged to emit second light, wherein the first light and the second light are different.

11. The lighting arrangement according to claim 1, wherein the lighting arrangement is flexible.

12. The lighting arrangement according to claim 1, wherein, in a cross section, P, of the lighting arrangement along the length direction, L, the lens body is further defined by an arc, D, between a first end point, Z₁, of the first side surface, S₁, and a second end point, Z₂, of the second side surface, S₂.

13. The lighting arrangement according to claim 1, wherein the second side surface, S₂, is perpendicular to the first side surface, S₂, whereby the first side surface, S₁, and the second side surface, S₂, define and span the lens body to have the shape of a quarter-circular cylinder.

14. The lighting arrangement according to claim 1, further comprising at least one incision provided perpendicular to the length direction, L, and along the length direction, L, in at least one of the lens body and the second side surface S2.
